(19) United States
(12) Patent Application Publication
(10) Pub. No.: US 2025/0258745 A1
(43) Pub. Date: Aug. 14, 2025

(54) COMPONENT TESTING USING LOG EVENTS

(71) Applicant: Capital One Services, LLC, McLean, VA (US)

(72) Inventors: Kirit NIMDIA, Henrico, VA (US); Nitin GOEL, Glen Allen, VA (US); Balasubrahmanya BALAKRISHNA, Glen Allen, VA (US); Anjal SHAH, Glen Allen, VA (US); Sweta TIWARY, Basking Ridge, NJ (US); Venkateshwarulu VANGA, Glen Allen, VA (US)

(21) Appl. No.: 18/438,892

(22) Filed: Feb. 12, 2024

(51) Int. Cl. G06F 11/263

(52) U.S. Cl. CPC G06F 11/2635

(57) ABSTRACT

In some implementations, a device may obtain input data to a component of an application, the input data having a data type. The device may determine, based on the data type, one or more log events that are indicative of one or more test conditions for the component and the data type. The device may obtain, based on an execution of the component, a subset of application log data, from a set of application log data, that is associated with the one or more log events. The device may determine, using the subset of application log data, whether the one or more test conditions are validated. The device may perform one or more actions based on whether the one or more test conditions are validated.

### BACKGROUND

Software testing is a phase in a software development life cycle encompassing various methodologies to ensure the reliability and functionality of a system (e.g., an application). Component testing (sometimes referred to as unit testing) may be associated with verifying the operation of individual units or components of the system in isolation. For example, component testing may include testing specific functions or modules to identify and fix defects at the component or unit level. Integration testing may include testing the interaction and integration of different components or modules within the system. Integration testing ensures that the combined components function seamlessly and may be configured to identify any issues arising from collaboration between components in the system. System testing may be associated with evaluating the complete system as a whole, confirming that the system meets specified requirements and operates cohesively in an intended environment. Collectively, these testing levels contribute to the overall quality assurance process, enhancing the robustness and reliability of software systems.

### SUMMARY

Some implementations described herein relate to a system for component testing using log events. The system may include one or more memories and one or more processors communicatively coupled to the one or more memories. The one or more processors may be configured to detect input data to a component of an application, the input data having a data type. The one or more processors may be configured to configure, based on the data type, one or more log events that are associated with one or more event indicators. The one or more processors may be configured to execute the component of the application. The one or more processors may be configured to obtain, based on the execution of the component, a subset of application log data from a set of application log data, wherein the subset of application log data includes at least one of the one or more event indicators, and wherein the set of application log data includes information indicative of an execution flow for the component of the application. The one or more processors may be configured to determine, using the subset of application log data, whether one or more test conditions are validated. The one or more processors may be configured to perform one or more actions based on whether the one or more test conditions are validated.

Some implementations described herein relate to a method for component testing using log events. The method may include obtaining, by a device, input data to a component of an application, the input data having a data type. The method may include determining, by the device and based on the data type, one or more log events that are indicative of one or more test conditions for the component and the data type. The method may include obtaining, by the device and based on an execution of the component, a subset of application log data, from a set of application log data, that is associated with the one or more log events. The method may include determining, by the device and using the subset of application log data, whether the one or more test conditions are validated. The method may include performing, by the device, one or more actions based on whether the one or more test conditions are validated.

Some implementations described herein relate to a non-transitory computer-readable medium that stores a set of instructions. The set of instructions, when executed by one or more processors of a device, may cause the device to detect input data to a component of an application, the input data having a data type. The set of instructions, when executed by one or more processors of the device, may cause the device to configure, based on the data type, one or more log events that are associated with one or more event indicators. The set of instructions, when executed by one or more processors of the device, may cause the device to collect, based on the execution of the component, a subset of application log data from a set of application log data, wherein the subset of application log data includes at least one of the one or more event indicators, and wherein the set of application log data includes information indicative of an execution flow for the component of the application. The set of instructions, when executed by one or more processors of the device, may cause the device to validate, using the subset of application log data, one or more test conditions.

### BRIEF DESCRIPTION OF THE DRAWINGS

FIGS. 1A-1D are diagrams of an example associated with component testing using log events, in accordance with some embodiments of the present disclosure.

FIG. 2 is a diagram of an example process associated with component testing using log events, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of a device associated with component testing using log events, in accordance with some embodiments of the present disclosure.

FIG. 5 is a flowchart of an example process associated with component testing using log events, in accordance with some embodiments of the present disclosure.

### DETAILED DESCRIPTION

The following detailed description of example implementations refers to the accompanying drawings. The same reference numbers in different drawings may identify the same or similar elements.

An application may include one or more components (e.g., modules or units) configured to operate together as part of a system. Component testing (or unit testing) may enable the components of the system to be isolated and separately tested. This may ensure that each component is functioning correctly on its own before integration with other components of the system. Component testing may enable early defect detection (e.g., because a component may be tested before integration into the system), facilitate code maintenance, support collaboration, and/or ensure the overall reliability and quality of the system, among other examples.

In some examples, a condition or rule for component testing may be defined using Gherkin feature stories. Gherkin is a domain-specific language used to write executable specifications for software and is designed to be easily readable by both technical and non-technical persons. Gherkin may be used to describe feature stories, scenarios, and acceptance criteria in a human-readable format (e.g., a given-when-then format). In some examples, a component being tested may be tested in a “black box” testing scenario where a testing system does not have knowledge of internal code structure, logic, or implementation details. In “black box” testing scenarios, the testing device may only access inputs to the component and outputs from the component and may treat the component as a “black box.” “Black box” testing scenarios provide an external perspective on software functionality, enabling testing without knowledge of the internal code, structure, or implementation and/or simulating how an end user interacts with the system. This provides a valuable approach to component testing.

However, testing “when” conditions may be challenging for component testing scenarios (e.g., a “when” condition may be defined as “when X occurs, then Y should happen”), such as in “black box” testing scenarios. For example, the testing system may be unable to determine if a given output was generated by following certain execution protocols or flows and/or by executing certain rules. As a result, the testing system may be unable to accurately evaluate some testing conditions (e.g., a “when” condition), which may result in deployment of a component that does not correctly function and/or that is unreliable. This may consume processing resources, network resources, memory resources, and/or result in security issues associated with the deployment of the component that does not correctly function and/or that is unreliable. Additionally, testing “when” conditions may be challenging for component testing scenarios may result in the testing system obtaining a large amount of data (e.g., all data or logs generated by the component) to determine if the testing conditions (e.g., a “when” condition) were met or satisfied. This may result in the testing device consuming significant memory resources associated with the testing operation.

Some implementations described herein enable component testing using log events. For example, the log events may include application log data generated by an application and/or a component of the application. The application and/or the component may generate application log data (sometimes referred to herein simply as “log data”) associated with an action or operation performed via the application and/or the component. Application log data may include data associated with events that have occurred associated with the application executing on a device. For example, application log data may identify one or more scripts, queries, operations, jobs, executed rules, errors, a quantity of attempts performed for a given task, and/or other information designed to provide information regarding the status of data processing jobs. In some implementations, a testing device may configure one or more log events that are associated with one or more event indicators. The one or more log events may identify log types or portions of application log data that includes information that is indicative of one or more testing conditions for component testing of the component of the application or system. In some implementations, the one or more log events may be based on a data type of input data to the component of the application or system.

For example, the testing device may detect input data (e.g., having a data type) to the component of the application. The testing device may configure, based on the data type, one or more log events (e.g., that are associated with one or more event indicators). The component of the application may be executed (e.g., the testing device may cause the component of the application to be executed and/or may execute the component of the application). The testing device may obtain, based on the execution of the component, a subset of application log data from a set of application log data. The set of application log data may include information indicative of an execution flow for the component of the application. The subset of application log data may be application log data that includes one or more of the event indicators for the log event(s).

The testing device may determine, using the subset of application log data, whether one or more test conditions are validated. For example, the testing device may analyze the subset of application log data. The testing device may validate one or more test conditions (e.g., for component testing) using the subset of application log data. The testing device may perform one or more actions based on whether the one or more test conditions are validated. For example, the testing device may validate the one or more test conditions and/or perform the one or more actions during the execution of the component. In some implementations, the testing device may detect, based on the subset of application log data, that an exception event for a function of the application has occurred. The testing device may cause a retry for the function to be performed (e.g., during the execution of the component) based on the exception event occurring.

As a result, the testing device may be enabled to perform component testing for test conditions that may otherwise be difficult and/or resource intensive to evaluate and/or validate. For example, by using the configured log events and/or the subset of log data to validate the one or more test conditions, the testing device may be enabled to evaluate test conditions associated with an execution flow of the component (e.g., without having knowledge of the internal code, structure, or implementation of the component) during an execution of the component. As a result, the testing device may be enabled to more efficiently and/or accurately perform component testing of the component (e.g., by evaluating test conditions for an (internal) execution flow of the component). For example, by using the configured log events and/or the subset of log data to validate the one or more test conditions, the testing device may be enabled to evaluate sequential code execution (e.g., the testing device may provide assurance that code executes in an intended order), exception handling, and/or retry handling (e.g., the testing device may validate that a retry flow is performed within a given time frame and/or may cause one or more retires to be performed), among other examples. The more efficient and/or accurate component testing may improve the performance and/or reliability of the component, thereby conserving processing resources, computing resources, network resources, and/or memory resources, among other examples, that would have otherwise been associated with deploying and/or executing the application that includes one or more components that have not been accurately or fully tested.

Additionally, by configuring the one or more log events and/or by validating the one or more test conditions using application log data collected based on the one or more configured log events, the testing device may collect relevant application log data for evaluating and/or validating the one or more test conditions. This may conserve processing resources, computing resources, and/or power resources, among other examples, of the testing device that would have otherwise been associated with analyzing all of the application log data generated by the component (e.g., which may include a large amount of irrelevant data for evaluating and/or validating the one or more test conditions). Additionally, by collecting and/or storing the subset of application log data, the testing device may conserve memory resources that would have otherwise been associated with collecting and/or storing the full set of application log data generated by the component.

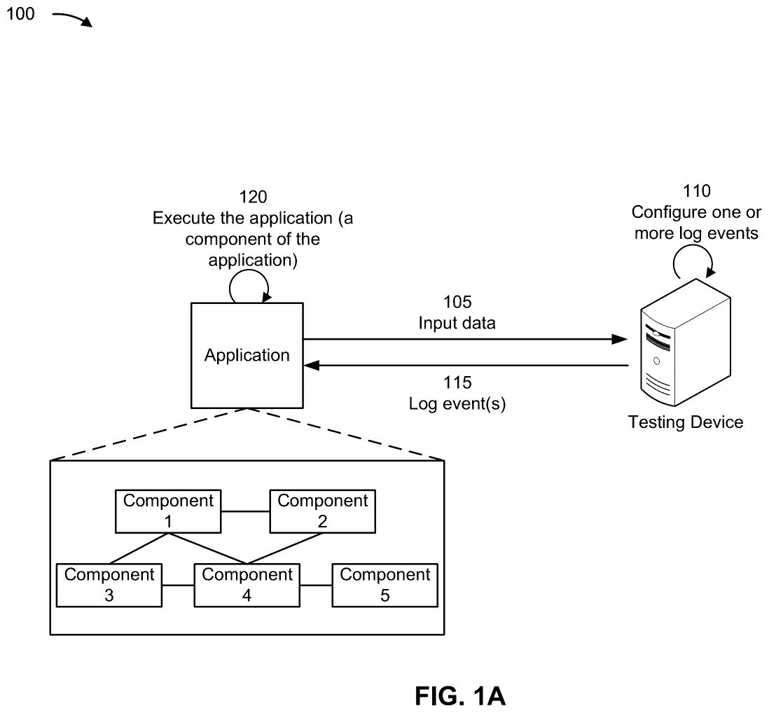

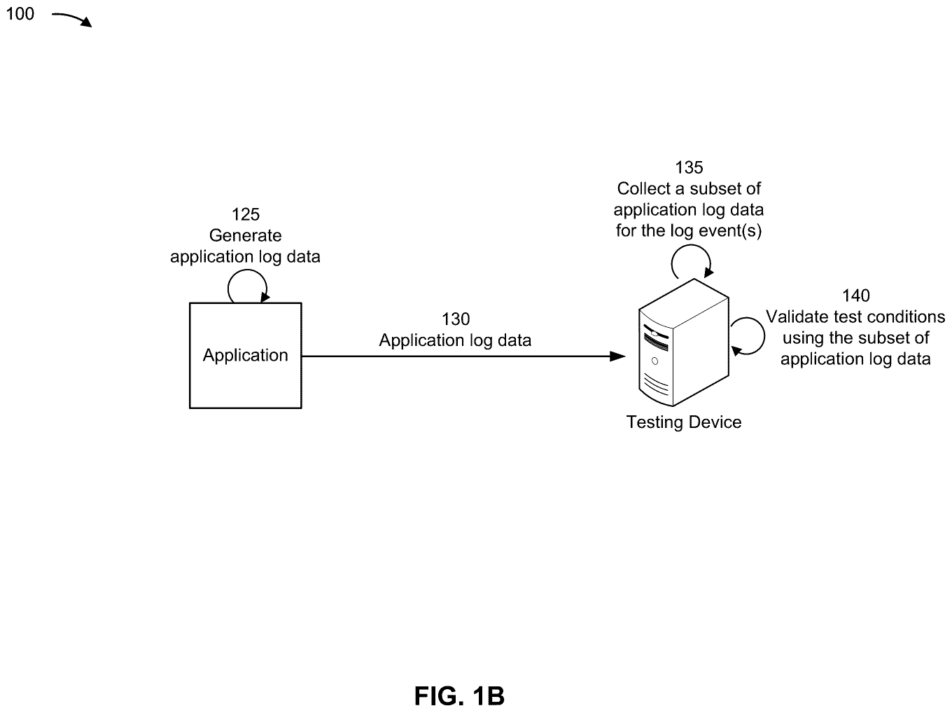

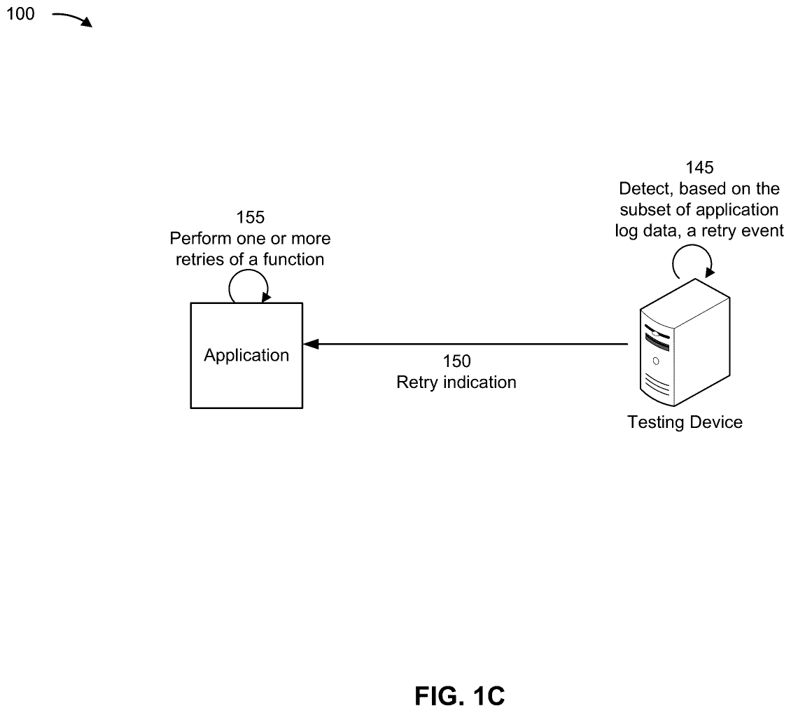

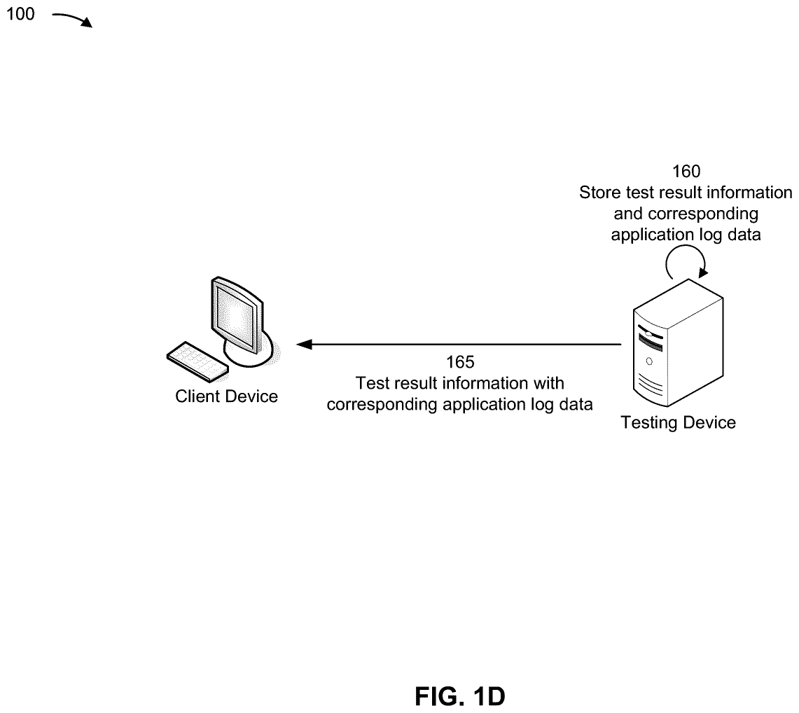

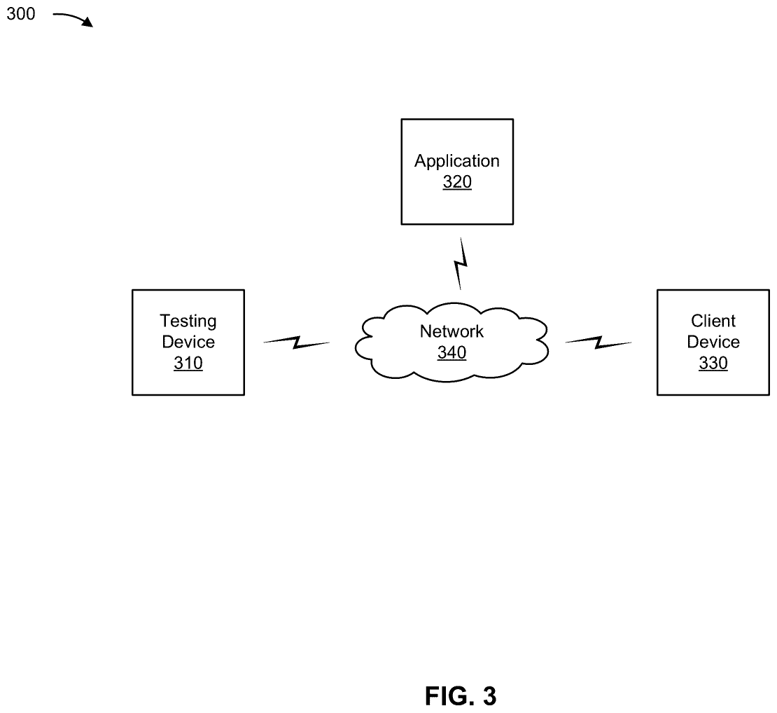

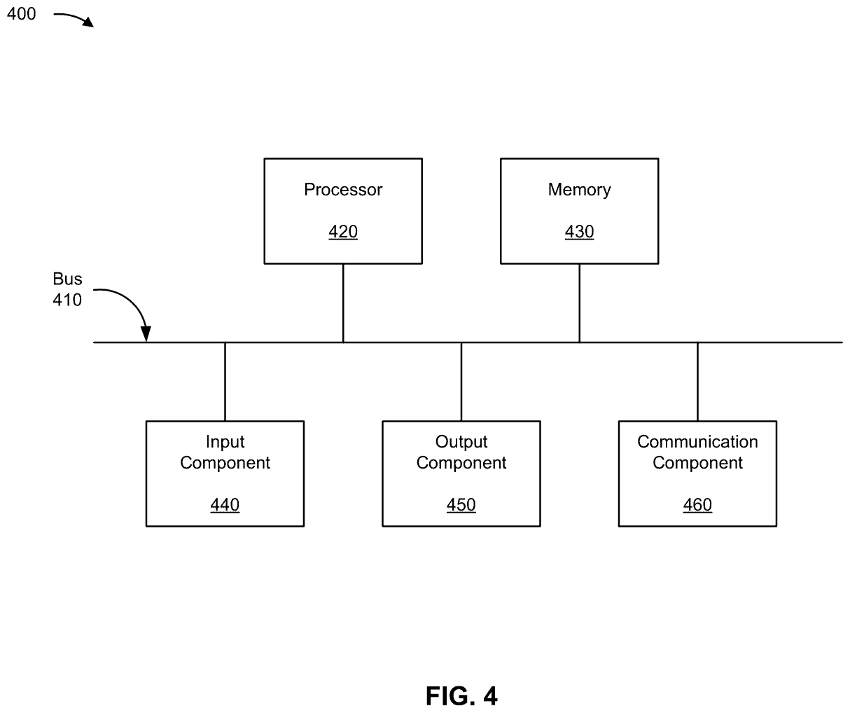

FIGS. 1A-1D are diagrams of an example 100 associated with component testing using log events. As shown in FIGS. 1A-1D, example 100 includes a testing device, an application (e.g., executing on a device, such as the testing device or another device), and a client device. These devices are described in more detail in connection with FIGS. 3 and 4.

As shown in FIG. 1A, the application may include one or more components. As used herein, a “component” of an application refers to a portion of an application that includes hardware, firmware, or a combination of hardware and software. A component may be a module and/or unit of an application that is independently executable and/or testable. For example, a component may be a part of an application (e.g., a module) that is capable of being isolated and independently executed and/or tested.

As shown in FIG. 1A, the application may include multiple components (shown as five components as an example) that are configured to integrate and/or communicate with each other to perform one or more tasks or jobs. For example, each component may serve a role in the overall functionality of the application. The interactions between components allows the application to process data, present information to users, maintain data integrity, communicate effectively, ensure security, and/or adapt to changing configurations, among other examples. The modular configuration of the components may enable scalability, flexibility, and/or reliability, among other examples, of the application. As an example, the one or more components may include a processing component (e.g., configured to perform one or more data processing operations), a data storage component (e.g., configured to read, write, modify, and/or store data), a user interface component (e.g., configured to manage interactions between the user interface and other components), a security component (e.g., configured to perform one or more operations for securing the application against unauthorized access, data breaches, and other security threats), a messaging component (e.g., configured to receive, generate, and/or transmit one or more messages), a configuration management component (e.g., configured to manage application settings, parameters, and/or configurations), among other examples.

As shown by reference number 105, the application (and/or a component) may provide, and the testing device may obtain, an indication of input data for the component. The component may be a component of the application that is under test (e.g., that is being tested via component testing). The testing device may detect the input data to the component of the application. For example, the testing device may receive the input data, may monitor input data to the component, and/or may provide the input data to the component, among other examples. In some implementations, the input data may be test data generated by the testing device or another device (e.g., data generated for the purpose of component testing of the component). As another example, the input data may be “real world” input data to the component obtained via an execution of the application.

The input data may be associated with (e.g., may have) a data type. The data type may indicate a category or type of data being provided as an input to the component. For example, different data types may trigger different flows, executions, and/or rules within the component. Therefore, the testing device may identify the data type of the input data being provided to the component to enable the testing device to accurately determine the steps, queries, rules, and/or flows, among other examples that should be performed by the component in response to the input data.

As shown by reference number 110, the testing device may configure one or more log events (e.g., for component testing of the component). The one or more log events may be based on the data type of the input data. For example, the testing device may determine one or more test conditions based on the data type of the input data. The one or more test conditions may identify one or more steps, queries, rules, and/or flows, among other examples that should be performed by the component in response to the input data. The one or more log events may identify parts or types of application log data that may include information that can be used to validate and/or evaluate the one or more test conditions.

The one or more log events may be associated with one or more event indicators. An event indicator may be information or a tag included in application log data that is indicative of a given log event. For example, the one or more event indicators may include a keyword, a flag (e.g., an event flag), and/or an event marker, among other examples. For example, configuring the one or more log events may include causing the component to include event indicators (e.g., for respective log events) in application log data generated by the component. As another example, configuring the one or more log events may include initializing the testing device to search for and/or monitor for the one or more event indicators (e.g., a list of keywords or other event indicators) in the application log data generated by the component.

In some implementations, configuring the one or more log events may include generating and/or configuring a log data extraction component (e.g., a log collector). The log data extraction component may be a component configured to monitor for, search for, and/or otherwise collect or obtain application log data corresponding to the one or more events. The testing device may configure, for the component, the log data extraction component to collect application log data that includes event indicators that are indicative of the one or more log events. For example, the testing device may configure the log data extraction component with the one or more log events. Configuring the log data extraction component with the one or more log events may cause the log data extraction component to obtain application log data corresponding to the one or more log events during an execution of the component.

The one or more log events may include a messaging event (e.g., for application log data associated with a downstream message provided by the component), an exception event (e.g., for application log data associated with an exception or error identified by the component during execution), an acknowledgement event (e.g., for application log data associated with an acknowledgement of a message or operation from another device or component), and/or a retry event (e.g., for application log data associated with any retries of a function or task performed by the component), among other examples. In some implementations, a log event may be configured and/or generated based on operations or events that occur during execution of the component. For example, a log event may be a conditional log event for which application log data is to be collected only if one or more conditions are met during the execution of the component. The one or more conditions may include an exception event occurring (e.g., an unexpected event or error that occurs during runtime and disrupts the normal flow of the component), and/or a retry operation being performed, among other examples.

In some implementations, as shown by reference number 115, the testing device may provide, and the application (and/or component) may obtain, the one or more log events. For example, configuring the one or more log events may include the testing device configuring the application and/or the component with the one or more log events. This may cause the application and/or the component to generate application log data with event indicators for respective log events of the one or more log events. Additionally, or alternatively, configuring the one or more log events may include the testing device configuring the application and/or the component with the one or more log events may cause a log collector of the application and/or the component to collect and/or provide application log data (e.g., corresponding the one or more log events) to the testing device (e.g., during the execution of the component).

As shown by reference number 120, a device (e.g., the testing device, the client device, or another device) may execute the application. For example, the device may execute the component of the application. As an example, executing the component of the application may include providing the input data to the component of the application. For example, the device may execute and/or activate a module or specific part of the code of the application corresponding to the component.

As shown in FIG. 1B, and by reference number 125, the application (e.g., the component) may generate application log data based on, in response to, or otherwise associated with executing the component. For example, the application and/or the component may generate a set of application log data. The set of application log data may include information indicative of an execution flow for the component of the application. For example, the set of application log data may include one or more scripts, queries, operations, jobs, executed rules, errors, a quantity of attempts performed for a given task, and/or other information designed to provide information regarding the status of data processing jobs.

For example, the component may (e.g., in response to obtaining the input data) perform one or more tasks, operations, and/or jobs to generate one or more outputs and/or to perform one or more operations with another component or device. As an example, the component may (e.g., in response to obtaining the input data) perform one or more tasks, operations, and/or jobs to communicate with another component, another device, and/or an application programming interface (API), among other examples. The set of application log data may include information indicative of the one or more scripts, queries, operations, jobs, executed rules, errors, a quantity of attempts performed for a given task, and/or other information indicative of the tasks, operations, and/or jobs performed by the component to generate the one or more outputs and/or to perform the one or more operations with another component or device. In some implementations, the set of application log data may be included in one or more log files.

As shown by reference number 130, the application (or component) may provide, and the testing device may obtain, the set of application log data. For example, the testing device may be configured to monitor and/or obtain the application log data generated by the component of the application. In some implementations, the application (or component) may provide, and the testing device may obtain, a subset of application log data from the set of application log data. For example, the application (or component) may be configured to identify the subset of application log data using the configured log event(s) (e.g., via a log data extraction component). In other implementations, the application (or component) may provide, and the testing device may obtain, the set of application log data and the testing device may identify the subset of application log data.

For example, as shown by reference number 135, the testing device may collect the subset of application log data for the log events. For example, the testing device (and/or the log data extraction component) may monitor and/or search the set of application log data for the one or more event indicators. For example, the testing device (and/or the log data extraction component) may obtain (e.g., via a stream or in another manner) application log data as the application log data is generated by the component (e.g., during the execution of the component). The testing device may detect or identify an event indicator in application log data. The testing device may extract or otherwise collect the application log data that includes the event indicator (and/or other application log data that is associated with or generated in connection with the application log data that includes the event indicator).

The subset of application log data may be application log data that includes at least one of the one or more event indicators. For example, by configuring the one or more log events, the testing device may be enabled to collect the subset of application log data corresponding to the one or more log events. This enables the testing device to obtain application log data that is indicative of an internal flow or functioning of the component for the one or more log events.

As shown by reference number 140, the testing device may validate the one or more test conditions using the subset of application log data. In some implementations, the testing device may validate the one or more test conditions during the execution of the application (e.g., while the application is being executed). The testing device may determine whether the subset of application log data indicates that an expected or configured execution flow for a function was performed by the component. For example, the testing device may determine, using the subset of application log data, whether the one or more test conditions are validated. For example, as described elsewhere herein, a test condition may identify one or more steps, queries, rules, and/or flows, among other examples that should be performed by the component in response to the input data and/or another event. If the subset of application log data indicates that the expected one or more steps, queries, rules, and/or flows, among other examples for a test condition were performed by the component, then the testing device may determine that the test condition is validated. If the subset of application log data indicates that the expected one or more steps, queries, rules, and/or flows, among other examples for a test condition were not performed by the component, then the testing device may determine that the test condition is not validated.

The testing device may identify one or more application logs (e.g., from the subset of application log data) that are associated with a given test condition. For example, the testing device may identify the one or more application logs using one or more event indicators for a log event that is associated with the given test condition. The testing device may analyze the one or more application logs (e.g., using natural language processing or another technique) to determine whether the one or more application logs indicate that the expected flow or execution for the given test condition (e.g., to determine whether the one or more application logs indicate that the expected steps, queries, rules, and/or flows, among other examples were performed).

In some implementations, a log event (or a test condition associated with a log event) may be associated with one or more rules being applied by the component during an execution flow of the component. In such examples, the testing device may determine whether the subset of application log data indicates that the one or more rules were applied. For example, the testing device may identify one or more application logs, from the subset of application log data, that are associated with the log event. The testing device may determine whether the one or more application logs indicate that the one or more rules were applied. If the one or more application logs indicate that the one or more rules were applied, then the testing device may determine that the test condition is validated. If the one or more application logs indicate that at least one of the one or more rules were not applied, then the testing device may determine that the test condition is not validated.

As another example, a log event (or a test condition associated with a log event) may be associated with an exception event. The testing device may detect, based on the subset of application log data, that the exception event occurred (e.g., one or more application logs may indicate that the exception event occurred during the execution of the component). The testing device may determine, based on detecting that the exception event occurred, whether the subset of application log data indicates that one or more exception event handling operations were performed. As an example, the one or more exception event handling operations may include performing one or more retry operations, generating and/or providing an error notification, and/or performing one or more other operations in response to the exception event occurring. If the subset of application log data indicates that the one or more exception event handling operations were performed, then the testing device may determine that the test condition (e.g., for the exception event) is validated. If the subset of application log data indicates that at least one of the one or more exception event handling operations were not performed, then the testing device may determine that the test condition (e.g., for the exception event) is not validated.

In some implementations, the testing device may detect, based on the subset of application log data, that an exception event for a function of the application has occurred. In such examples, the testing device may determine, based on the subset of application log data, whether a retry (e.g., one or more retry operations) for the function was performed based on the exception event occurring. A “retry” or “retry operation” may refer to the component attempting to perform a task, operation, or job that has previously failed or experienced an exception event. In some implementations, if the subset of application log data indicates that the retry for the function was performed, then the testing device may determine that a test condition (e.g., for retry functionality) is validated. If the subset of application log data indicates that the retry for the function was not performed, then the testing device may determine that the test condition (e.g., for retry functionality) is not validated. In some implementations, the testing device may determine whether a quantity of retries performed by the component (e.g., before declaring a failure) satisfies a retry threshold (e.g., that may be defined by the test condition for retry functionality). For example, the testing device may determine whether the component attempted to perform a task, operation, or job for the function the requisite quantity of times before declaring a failure and/or before performing another operation.

The testing device may perform one or more actions based on determining whether the one or more test conditions are validated. In some implementations, the testing device may perform the one or more actions during the execution of the component. For example, as shown in FIG. 1C, and by reference number 145, the testing device may detect, based on the subset of application log data, a retry event. The retry event may refer to an exception event or another event indicated by the subset of application log data that indicates an operation is to be retried. For example, the testing device may determine that the subset of application log data indicates that an operation or a function was not successfully performed. As another example, the testing device may determine that the subset of application log data indicates that an exception event has occurred.

As shown by reference number 150, the testing device may provide, and the application (e.g., the component) may obtain, a retry indication. The retry indication may be a message, indication, and/or flag, among other examples, to cause the component to perform one or more retry operations for the operation or function that was indicated (e.g., by the subset of application log data) as being unsuccessfully performed. In some implementations, the retry indication may indicate a quantity of retries to be performed by the component for the operation or function. In other words, the testing device may cause, based on detecting that the retry event, one or more retries for a function to be performed. For example, the testing device may cause, based on detecting that an exception event has occurred, one or more retries for a function to be performed by the component.

As shown by reference number 155, the component may perform the one or more retries of the function (e.g., based on, or in response to, obtaining the retry indication from the testing device). As a result, the testing device may enable automated retries for failed or unsuccessful events during the execution of the component of the application. The component of the application may generate application log data associated with the one or more retries of the function. The testing device may obtain this application log data and evaluate or validate one or more test conditions in a similar manner as described in more detail elsewhere herein. This may conserve processing resources, network resources, computing resources, and/or time that would have otherwise been associated with identifying the exception or event or failure of the function after the execution of the component, causing the component to be executed again to perform the function, and/or evaluating the performance of the function after re-executing the component.

In some implementations, the subset of application log data may be used for one or more integration test conditions that are associated with multiple components of the application (and/or components or devices external to the application). For example, the testing device may use the subset of application log data for the component (and/or similar application log data from other components) to evaluate test conditions that are associated with a communication or integration between the component and the other components. This may improve the testing for the integration of the components in real-time while the application is being executed.

As shown in FIG. 1D, and by reference number 160, the testing device may store test result information and corresponding application log data. The test result information may indicate whether the one or more test conditions are validated. In some implementations, the corresponding application log data may be application logs that include information that is indicative of whether the one or more test conditions are validated. In some implementations, the corresponding application log data may only include application logs that include information that is indicative that a test condition is not validated. For example, application logs indicating that a test condition was validated may be less useful for review and/or debugging than application logs indicating that a test condition was not validated. Therefore, in some cases, the testing device may only store application log data that includes information that is indicative that a test condition is not validated (e.g., to conserve memory resources).

In some implementations, as shown by reference number 165, the testing device may provide, and the client device may obtain, the test result information with the corresponding application log data. In some implementations, the testing device may provide the test result information based on, or in response to, determining that one or more test conditions were not validated. In other implementations, the testing device may provide the test result information based on, or in response to, determining that a testing operation is completed.

In some implementations, the corresponding application log data provided to the client device may include the subset of application log data. As a result, only the relevant application log data for evaluating the test condition(s) may be provided to the client device. This may conserve memory resources, processing resources, and/or network resources, among other examples, that would have otherwise been associated with providing all application log data generated by the component to the client device. Additionally, this may conserve memory resources, processing resources, and/or network resources, among other examples, that would have otherwise been associated with the client device being used to analyze or evaluate all application log data generated by the component to the client device to evaluate the one or more test conditions and/or to debug the component, among other examples.

As indicated above, FIGS. 1A-1D are provided as an example. Other examples may differ from what is described with regard to FIGS. 1A-1D.

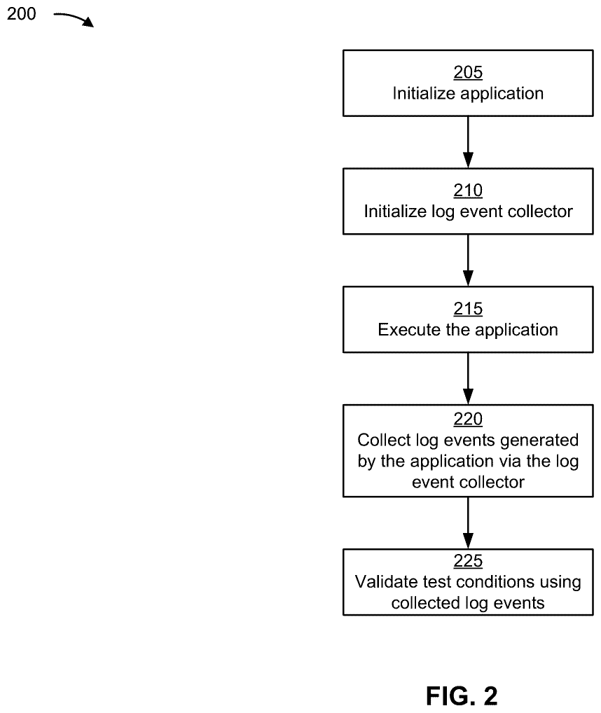

FIG. 2 is a diagram of an example process 200 associated with component testing using log events. The example process 200 may be performed by the testing device. Additionally, or alternatively, the example process 200 may be performed by the application and/or the client device, among other examples. These devices are described in more detail in connection with FIGS. 3 and 4.

As shown in FIG. 2, the process 200 may include initializing an application (e.g., the application described elsewhere herein) (block 205). For example, the testing device (or another device) may initialize the application, such as by loading and/or configuring code or a module for a component of the application to be tested. The process 200 may include initializing a log event collector (block 210). For example, the testing device may initialize the log event collector. The log event collector may be the log data extraction component described elsewhere herein. Initializing the log event collector may include the testing device configuring one or more log events for which application log data is to be collected (e.g., for evaluation or validation of test conditions), as described in more detail elsewhere herein.

The process 200 may include executing the application (block 215). For example, the testing device (or another device) may cause the application (or a component of the application) to be executed. The process 200 may include collecting log events generated by the application via the log event collector (block 220). For example, the testing device may collect the subset of application log data (e.g., described in more detail elsewhere herein) via the log event collector. The log event collector may be configured to store the collected application log data in memory of the application and/or of the testing device. The log event collector enables synchronization between a current state of the application and expected outcomes defined by the testing device and/or enables seamless transmission of the application log data by providing a structured repository for collected application log data. This mitigates synchronization challenges and facilitates accurate validation, enabling a more robust and streamlined approach to the component testing process.

The process 200 may include validating one or more test conditions using the collected log events (block 225). For example, the testing device may validate or evaluate the one or more test conditions using the collected application log data, as described in more detail elsewhere herein. As a result, the testing device may be enabled to evaluate the internal flow of applications during component testing. This enhances the precision and effectiveness of testing procedures within the individual components of the application. By utilizing application log collection as an event-driven mechanism for comprehensive validation and assertion of the flow of the application, the testing of individual components of the application may be improved. Additionally, by utilizing application log collection as an event-driven mechanism for component tests, the testing device may enable improved control over checkpoints and event logging, offering increased flexibility and customization in the validation process of defined test conditions. Further, the testing device may be enabled to validate the test conditions in real-time while the application is executing.

As indicated above, FIG. 2 is provided as an example. Other examples may differ from what is described with regard to FIG. 2.

FIG. 3 is a diagram of an example environment 300 in which systems and/or methods described herein may be implemented. As shown in FIG. 3, environment 300 may include testing device 310, an application 320, a client device 330, and a network 340. Devices of environment 300 may interconnect via wired connections, wireless connections, or a combination of wired and wireless connections.

The testing device 310 may include one or more devices capable of receiving, generating, storing, processing, providing, and/or routing information associated with component testing using log events, as described elsewhere herein. The testing device 310 may include a communication device and/or a computing device. For example, the testing device 310 may include a server, such as an application server, a client server, a web server, a database server, a host server, a proxy server, a virtual server (e.g., executing on computing hardware), or a server in a cloud computing system. In some implementations, the testing device 310 may include computing hardware used in a cloud computing environment.

The application 320 may include one or more devices capable of receiving, generating, storing, processing, providing, and/or routing information associated with component testing using log events, as described elsewhere herein. The application 320 may include one or more devices or components configured to execute code or instructions for an application or system. The application 320 may include a communication device and/or a computing device. For example, the application 320 may include a server, such as an application server, a client server, a web server, a database server, a host server, a proxy server, a virtual server (e.g., executing on computing hardware), or a server in a cloud computing system. In some implementations, the application 320 may include computing hardware used in a cloud computing environment.

The client device 330 may include one or more devices capable of receiving, generating, storing, processing, and/or providing information associated with component testing using log events, as described elsewhere herein. The client device 330 may include a communication device and/or a computing device. For example, the client device 330 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The network 340 may include one or more wired and/or wireless networks. For example, the network 340 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 340 enables communication among the devices of environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of a device 400 associated with component testing using log events. The device 400 may correspond to the testing device 310, the application 320, and/or the client device 330. In some implementations, the testing device 310, the application 320, and/or the client device 330 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

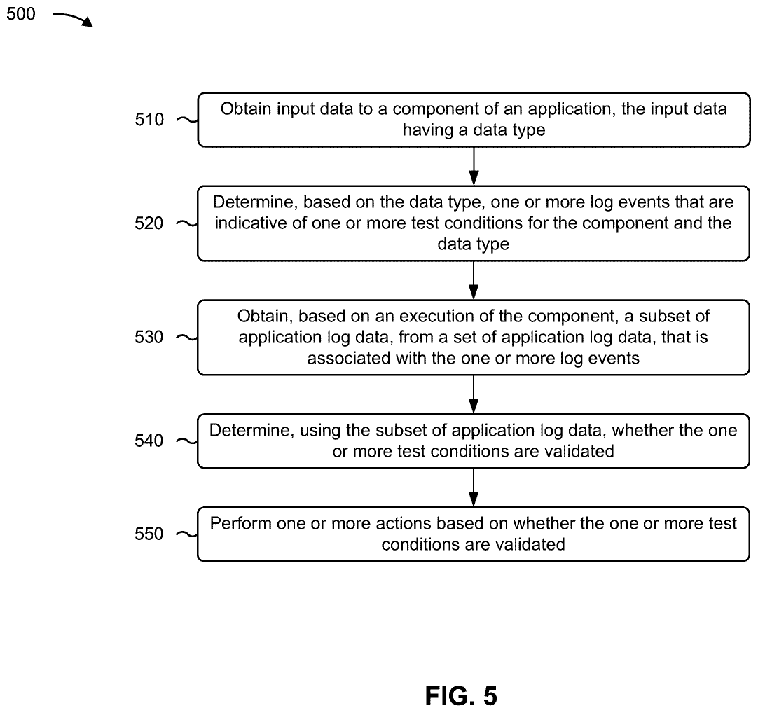

FIG. 5 is a flowchart of an example process 500 associated with component testing using log events. In some implementations, one or more process blocks of FIG. 5 may be performed by the testing device 310. In some implementations, one or more process blocks of FIG. 5 may be performed by another device or a group of devices separate from or including the testing device 310, such as the application 320, and/or the client device 330. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include obtaining input data to a component of an application, the input data having a data type (block 510). For example, the testing device 310 (e.g., using processor 420 and/or memory 430) may obtain input data to a component of an application, the input data having a data type, as described above in connection with reference number 105 of FIG. 1A. As an example, the testing device 310 may detect the data type of input data that is being provided to the component of the application.

As further shown in FIG. 5, process 500 may include determining, based on the data type, one or more log events that are indicative of one or more test conditions for the component and the data type (block 520). For example, the testing device 310 (e.g., using processor 420 and/or memory 430) may determine, based on the data type, one or more log events that are indicative of one or more test conditions for the component and the data type, as described above in connection with reference number 110 of FIG. 1A. As an example, a test condition may define one or more steps, queries, rules, operations, and/or tasks, among other examples, that are to be performed, executed, or applied in response to a given scenario or condition. The testing device 310 may determine one or more test conditions to be tested based on the data type of the input data. For example, different data types may cause the component to perform different tasks or operations. Therefore, the testing device 310 may determine the test conditions to be validated for the component based on the data type of the input data being provided to the component. The testing device 310 may determine log events that will produce log data that includes information indicative of whether the one or more test conditions are validated. The testing device 310 may configure the one or more log events (e.g., for the component and/or a log event collector) to cause application log data to be collected for the one or more log events.

As further shown in FIG. 5, process 500 may include obtaining, based on an execution of the component, a subset of application log data, from a set of application log data, that is associated with the one or more log events (block 530). For example, the testing device 310 (e.g., using processor 420 and/or memory 430) may obtain, based on an execution of the component, a subset of application log data, from a set of application log data, that is associated with the one or more log events, as described above in connection with reference number 130 of FIG. 1B. As an example, a log event collector may be configured to identify, obtain, and/or store application log data (e.g., the subset of application log data) that includes event indicators for the one or more log events. The testing device 310 may obtain the collected subset of application log data based on the log event collector collecting the subset of application log data.

As further shown in FIG. 5, process 500 may include determining, using the subset of application log data, whether the one or more test conditions are validated (block 540). For example, the testing device 310 (e.g., using processor 420 and/or memory 430) may determine, using the subset of application log data, whether the one or more test conditions are validated, as described above in connection with reference number 140 of FIG. 1B. As an example, the testing device 310 may determine whether the subset of application log data indicates that steps, queries, rules, operations, and/or tasks, among other examples, for each test condition were performed by the component.

As further shown in FIG. 5, process 500 may include performing one or more actions based on whether the one or more test conditions are validated (block 550). For example, the testing device 310 (e.g., using processor 420 and/or memory 430) may perform one or more actions based on whether the one or more test conditions are validated, as described above in connection with reference number 145 or reference number 150 of FIG. 1C and/or reference number 160 or reference number 165 of FIG. 1D. As an example, the testing device 310 may perform the one or more actions during the execution of the component (e.g., while the component is being executed). For example, the one or more actions may include causing the component to perform one or more retry operations for a function that is indicated (e.g., by the subset of application log data) as being associated with an exception event and/or as being unsuccessfully performed. As another example, the one or more actions may include providing, to the client device 330, an indication of whether the one or more test conditions were validated and the subset of application log data to support the validation(s).

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1D and/or FIG. 2. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for component testing using log events, the system comprising:
one or more memories; and
one or more processors, communicatively coupled to the one or more memories, configured to:
detect input data to a component of an application, the input data having a data type;
configure, based on the data type, one or more log events that are associated with one or more event indicators;
execute the component of the application;
obtain, based on the execution of the component, a subset of application log data from a set of application log data,
wherein the subset of application log data includes at least one of the one or more event indicators, and
wherein the set of application log data includes information indicative of an execution flow for the component of the application;
determine, using the subset of application log data, whether one or more test conditions are validated; and
perform one or more actions based on whether the one or more test conditions are validated.

2. The system of claim 1, wherein the one or more processors, to perform the one or more actions, are configured to:
perform the one or more actions during the execution of the component and in association with a function of the application.

3. The system of claim 1, wherein the one or more processors, to determine whether the one or more test conditions are validated, are configured to:
detect, based on the subset of application log data, that an exception event for a function of the application has occurred; and
determine, based on the subset of application log data, whether a retry for the function was performed based on the exception event occurring.

4. The system of claim 3, wherein the one or more processors, to perform the one or more actions, are configured to:
cause the retry for the function to be performed based on determining that the retry was not performed based on the exception event occurring.

5. The system of claim 1, wherein the one or more processors, to perform the one or more actions, are configured to:
detect, based on the subset of application log data, that an exception event for a function of the application has occurred; and
cause, based on detecting that the exception event has occurred, one or more retries for the function to be performed.

6. The system of claim 1, wherein a log event, of the one or more log events, is associated with one or more rules being applied by the component during the execution flow, and wherein the one or more processors, to determine whether the one or more test conditions are validated, are configured to:
determine whether the subset of application log data indicates that the one or more rules were applied.

7. The system of claim 1, wherein a log event, of the one or more log events, is associated with an exception event, and wherein the one or more processors, to determine whether the one or more test conditions are validated, are configured to:
detect, based on the subset of application log data, that the exception event occurred; and
determine, based on detecting that the exception event occurred, whether the subset of application log data indicates that one or more exception event handling operations were performed.

8. The system of claim 1, wherein the one or more event indicators include at least one of:
a keyword,
a flag, or
an event marker.

9. A method for component testing using log events, comprising:
obtaining, by a device, input data to a component of an application, the input data having a data type;
determining, by the device and based on the data type, one or more log events that are indicative of one or more test conditions for the component and the data type;
obtaining, by the device and based on an execution of the component, a subset of application log data, from a set of application log data, that is associated with the one or more log events;
determining, by the device and using the subset of application log data, whether the one or more test conditions are validated; and
performing, by the device, one or more actions based on whether the one or more test conditions are validated.

10. The method of claim 9, wherein obtaining the subset of application log data comprises:
configuring, for the component, a log data extraction component to collect application log data that includes event indicators that are indicative of the one or more log events.

11. The method of claim 9, wherein performing the one or more actions comprises:
performing the one or more actions during the execution of the component and in association with a function of the application.

12. The method of claim 9, wherein determining whether the one or more test conditions are validated comprises:
detecting, based on the subset of application log data, that an exception event for a function of the application has occurred; and
determining, based on the subset of application log data, whether a retry for the function was performed based on the exception event occurring.

13. The method of claim 9, wherein performing the one or more actions comprises:
detecting, based on the subset of application log data, a retry event for a function of the application; and
causing, based on detecting that the retry event, one or more retries for the function to be performed.

14. The method of claim 9, wherein determining whether the one or more test conditions are comprises:
determining whether the subset of application log data indicates that an execution flow for a function was performed.

15. The method of claim 9, wherein a log event, of the one or more log events, is associated with an exception event, and wherein determining whether the one or more test conditions are comprises:
detecting, based on the subset of application log data, that the exception event occurred; and
determining, based on detecting that the exception event occurred, whether the subset of application log data indicates that one or more exception event handling operations were performed.

16. A non-transitory computer-readable medium storing a set of instructions, the set of instructions comprising:
one or more instructions that, when executed by one or more processors of a device, cause the device to:
detect input data to a component of an application, the input data having a data type;
configure, based on the data type, one or more log events that are associated with one or more event indicators;
collect, based on the execution of the component, a subset of application log data from a set of application log data,
wherein the subset of application log data includes at least one of the one or more event indicators, and
wherein the set of application log data includes information indicative of an execution flow for the component of the application; and
validate, using the subset of application log data, one or more test conditions.

17. The non-transitory computer-readable medium of claim 16, wherein the one or more instructions, that cause the device to validate the one or more test conditions, cause the device to:
detect, based on the subset of application log data, that an exception event for a function of the application has occurred; and
determine, based on the subset of application log data, whether a retry for the function was performed based on the exception event occurring.

18. The non-transitory computer-readable medium of claim 16, wherein the one or more instructions further cause the device to:
detect, based on the subset of application log data, that an exception event for a function of the application has occurred; and
cause, based on detecting that the exception event has occurred, one or more retries for the function to be performed.

19. The non-transitory computer-readable medium of claim 16, wherein a log event, of the one or more log events, is associated with one or more rules being applied by the component during the execution flow, and wherein the one or more processors, to validate the one or more test conditions, are configured to:
determine whether the subset of application log data indicates that the one or more rules were applied.

20. The non-transitory computer-readable medium of claim 16, wherein a log event, of the one or more log events, is associated with an exception event, and wherein the one or more processors, to validate the one or more test conditions, are configured to:
detect, based on the subset of application log data, that the exception event occurred; and
determine, based on detecting that the exception event occurred, whether the subset of application log data indicates that one or more exception event handling operations were performed.
